(19) United States
(12) Patent Application Publication
(10) Pub. No.: US 2023/0102024 A1
(43) Pub. Date: Mar. 30, 2023

(54) ELECTRIFIED VEHICLE

(71) Applicants: TOYOTA JIDOSHA KABUSHIKI KAISHA, Toyota-shi Aichi-Ken (JP); SUBARU CORPORATION, Shibuya-Ku Tokyo (JP)

(72) Inventor: Junichi Murase, Aichi-gun (JP)

(73) Assignees: TOYOTA JIDOSHA KABUSHIKI KAISHA, Toyota-shi Aichi-Ken (JP); SUBARU CORPORATION, Shibuya-Ku Tokyo (JP)

(21) Appl. No.: 17/863,817

(22) Filed: Jul. 13, 2022

(30) Foreign Application Priority Data
Sep. 24, 2021 (JP) 2021-155788

(51) Int. Cl. B60L 15/00; B60L 7/18; B60L 58/12; B60L 3/00; B60L 7/26; B60T 8/32; B60T 8/1761

(52) U.S. Cl. CPC B60L 15/00; B60L 7/18; B60L 58/12; B60L 3/0061; B60L 7/26; B60T 8/3215; B60T 8/17616; B60L 2240/48; B60T 2270/10; B60T 2270/604; B60T 2240/00; B60T 2260/09

(57) ABSTRACT

In an electrified vehicle, a vibration damping control device performs vibration damping control for canceling or reducing, with the use of regenerative braking, a predetermined vibration component by monitoring the vibration component and controlling a generator control device depending on the vibration component. A system control device determines whether the vibration damping control is performable based on at least a charge status of a battery. An anti-lock braking system control device transmits a request signal to the system control device while performing anti-lock braking system control. The system control device transmits a command signal to the vibration damping control device when the vibration damping control is determined to be performable and the request signal is received from the anti-lock braking system control device. The vibration damping control device performs the vibration damping control when the command signal is received from the system control device.

### CROSS-REFERENCE TO RELATED APPLICATION

This application claims priority to Japanese Patent Application No. 2021-155788 filed on Sep. 24, 2021, incorporated herein by reference in its entirety.

### BACKGROUND

### 1. Technical Field

The present disclosure relates to an electrified vehicle. In particular, the present disclosure relates to an electrified vehicle including a generator control device configured to control regenerative braking performed by a motor generator, and an anti-lock braking system (ABS) control device configured to perform ABS control for avoiding or restraining wheel locking.

### 2. Description of Related Art

An electrified vehicle of Japanese Unexamined Patent Application Publication No. 2019-122053 (JP 2019-122053 A) includes an ABS control device, a generator control device (referred to as “regenerative control unit” in JP 2019-122053 A), and a system control device (referred to as “coordination control unit” in JP 2019-122053 A) for coordinating the ABS control device and the generator control device. The ABS control device performs ABS control for avoiding or restraining wheel locking. In the ABS control, a wheel slip ratio is calculated from a wheel rotation speed, and a mechanical braking force (for example, a hydraulic braking force) is applied to wheels to keep the wheel slip ratio within a predetermined range. The generator control device controls a motor generator based on a regenerative braking force command value received from the system control device during the ABS control. The system control device calculates the regenerative braking force command value depending on a charge status of a battery of the electrified vehicle. The regenerative braking force generated by the motor generator is more responsive than the mechanical braking force. In the electrified vehicle of JP 2019-122053 A, the system control device controls the mechanical braking force and the regenerative braking force in coordination to apply the regenerative braking force generated by the motor generator to the wheels before the mechanical braking force is applied to the wheels.

### SUMMARY

The ABS control device of JP 2019-122053 A performs the ABS control based on the wheel rotation speed. The wheel rotation speed includes a vibration component having a specific frequency due to, for example, a vibration caused in a drive system including the motor generator and an external force applied to drive wheels from a road surface. Such a vibration component is a harmful disturbance in the ABS control to reduce the accuracy of the ABS control. In this regard, the inventor et al. have developed a technology for canceling or reducing the vibration component in the wheel rotation speed with the use of the regenerative braking performed by the motor generator (hereinafter the technology will be referred to as “vibration damping control”). However, the operation of regenerative braking may be prohibited or restricted depending on, for example, the charge status of the battery. If the vibration damping control is performed during the ABS control in such a situation, influence of the insufficient vibration damping control may be a new disturbance in the ABS control.

The present disclosure provides a technology for appropriately performing vibration damping control using regenerative braking during ABS control.

An electrified vehicle according to one aspect of the present disclosure includes a motor generator, a battery, a generator control device, a braking device, an anti-lock braking system control device, a vibration damping control device, and a system control device. The motor generator is configured to drive a wheel. The battery is connected to the motor generator. The generator control device is configured to control regenerative braking performed by the motor generator. The braking device is configured to mechanically brake the wheel. The anti-lock braking system control device is configured to perform anti-lock braking system control for avoiding or restraining locking of the wheel by monitoring a rotation speed of the wheel and controlling the braking device depending on the rotation speed. The vibration damping control device is configured to perform vibration damping control for canceling or reducing, with use of the regenerative braking, a predetermined vibration component generated in a rotation speed of the motor generator, by monitoring the predetermined vibration component and controlling the generator control device depending on the predetermined vibration component. The system control device is configured to determine whether the vibration damping control is performable based on at least a charge status of the battery. In the electrified vehicle according to the one aspect of the present disclosure, the anti-lock braking system control device is configured to transmit a request signal to the system control device while the anti-lock braking system control device is performing the anti-lock braking system control. The system control device is configured to transmit a command signal to the vibration damping control device when the system control device determines that the vibration damping control is performable and receives the request signal from the anti-lock braking system control device. The vibration damping control device is configured to perform the vibration damping control when the vibration damping control device receives the command signal from the system control device. The charge status of the battery herein means a charge level compared with full charge of the battery, and means an index such as a state of charge (SOC).

In the configuration described above, the system control device is interposed between the anti-lock braking system control device that performs the anti-lock braking system control and the vibration damping control device that performs the vibration damping control. The system control device can determine whether the vibration damping control is performable based on, for example, the charge status of the battery. The system control device transmits the request signal that has been sent from the anti-lock braking system control device, as the command signal, to the vibration damping control device only under a situation in which the vibration damping control is performable. As a result, it is possible to avoid an unintended decrease in the accuracy of the anti-lock braking system control because the vibration damping control is not insufficiently performed during the anti-lock braking system control.

Details and further improvements of the technology of the present disclosure will be described in the “DETAILED DESCRIPTION OF EMBODIMENTS” section below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of an electrified vehicle 10 according to an embodiment;

FIG. 2 is a block diagram of a control device 20;

FIG. 3 is a graph showing a relationship between a wheel rotation speed V1 and an estimated speed Vs in time sequence, in which a horizontal axis represents time (T) and a vertical axis represents magnitudes (V) of the speeds V1 and Vs;

FIG. 4 is a graph showing a change in a friction force F1 in time sequence, in which a horizontal axis represents time (T) and a vertical axis represents a magnitude (P) of the friction force F1; and

FIG. 5 shows a flow of a system control process to be performed by a system control device 22.

### DETAILED DESCRIPTION OF EMBODIMENTS

In one embodiment of the present disclosure, the system control device may be configured to determine whether the vibration damping control is performable based further on a limit value for charging of the battery. Examples of the limit value for the charging include permissible (maximum) charging power of the battery and a permissible (maximum) charging current of the battery. The limit value for the charging means an index that may temporarily be limited depending on, for example, the temperature of the battery. The system control device can determine more accurately whether the vibration damping control is performable in further consideration of such an index.

In one embodiment of the present disclosure, the system control device may be configured to determine whether the vibration damping control is performable based further on a limit value for the regenerative braking performed by the motor generator. Examples of the limit value for the regenerative braking include permissible (maximum) regenerative power of the motor generator and a permissible (maximum) regenerative current of the motor generator. The limit value for the regenerative braking means an index that may temporarily be limited depending on, for example, the temperature of the motor generator. The system control device can determine more accurately whether the vibration damping control is performable in further consideration of such an index.

In one embodiment of the present disclosure, the system control device may be configured to calculate, based on a limit value for charging of the battery, a first maximum regenerative torque outputtable in the regenerative braking by the motor generator, calculate, based on a limit value for the regenerative braking performed by the motor generator, a second maximum regenerative torque outputtable in the regenerative braking by the motor generator, and determine that the vibration damping control is performable when a minimum value out of the first maximum regenerative torque and the second maximum regenerative torque is larger than a required torque threshold that is a value of a torque required for the vibration damping control. With the configuration, it is possible to appropriately determine whether the vibration damping control is performable by converting different indices such as the limit value for the charging of the battery and the limit value for the regenerative braking performed by the motor generator into a common index that is a torque.

In one embodiment of the present disclosure, the system control device may be configured to transmit a permission signal to the anti-lock braking system control device when the system control device determines that the vibration damping control is performable. In this case, the anti-lock braking system control device may be configured to transmit the request signal to the system control device when the anti-lock braking system control receives the permission signal and is performing the anti-lock braking system control. With the configuration, the anti-lock braking system control device can grasp in advance whether the vibration damping control is performable based on the permission signal from the system control device. Thus, the anti-lock braking system control device can change, for example, a control parameter of the anti-lock braking system control such that the control parameter under the situation in which the vibration damping control can be expected is different from the control parameter under the situation in which the vibration damping control cannot be expected.

In one embodiment of the present disclosure, the system control device may be configured to determine whether the vibration damping control is performable based further on whether an abnormality has occurred in the motor generator. With the configuration, it is possible to restrain the vibration damping control from being performed when an abnormality has occurred in the motor generator. As a result, it is possible to reduce the possibility that a load due to the vibration damping control is additionally applied to the motor generator having the abnormality.

In one embodiment of the present disclosure, the electrified vehicle may further include a shift lever. In that case, the system control device may be configured to determine whether the vibration damping control is performable based further on whether the shift lever is in a drive position. With the configuration, it is possible to reduce the possibility that the vibration damping control is unnecessarily performed when the shift lever is in, for example, a parking position.

### Embodiment

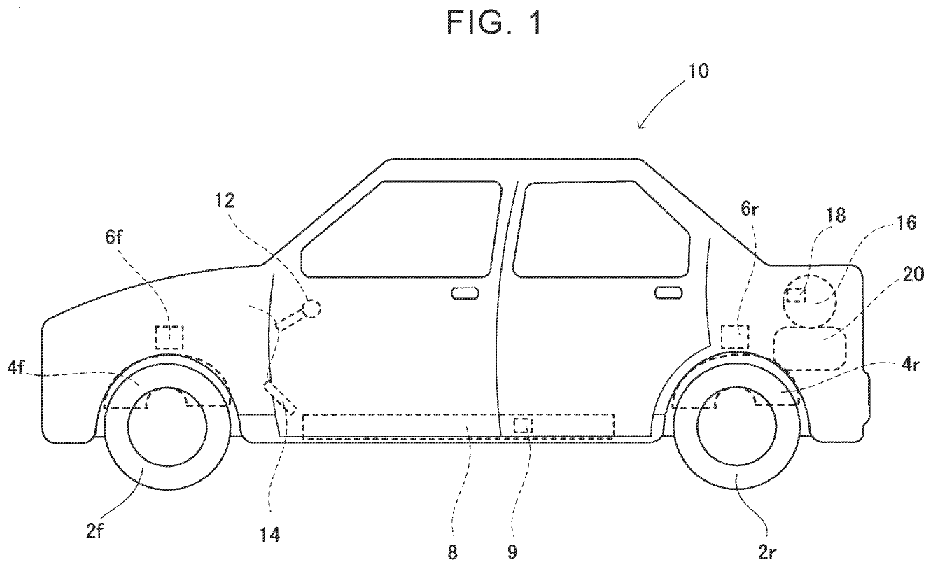

An electrified vehicle according to an embodiment will be described with reference to the drawings. FIG. 1 is a side view schematically showing an electrified vehicle 10 of the embodiment. The electrified vehicle 10 includes front wheels 2f, rear wheels 2r, a battery 8, a shift lever 12, a brake pedal 14, a motor generator 16, and a control device 20. In the electrified vehicle 10, the motor generator 16 is driven by supplying electric power of the battery 8 to the motor generator 16. As a result, the motor generator 16 drives the front wheels 2f and the rear wheels 2r. Thus, the electrified vehicle 10 travels.

The brake pedal 14 is connected to front brakes 4f that brake the front wheels 2f, and rear brakes 4r that brake the rear wheels 2r. When a user of the electrified vehicle depresses the brake pedal 14, the brakes 4f and 4r press discs (not shown) fixed to the wheels 2f and 2r with the use of hydraulic pressures, based on a depression amount. As a result, a friction force is generated between the disc and each of the brakes 4f and 4r to brake each of the wheels 2f and 2r. In this way, in the electrified vehicle 10, the wheels 2f and 2r are mechanically braked by the brakes 4f and 4r.

In the electrified vehicle 10, regenerative braking can be performed by the motor generator 16. When the regenerative braking is performed, the motor generator 16 generates a torque in a direction opposite to that during traveling. As a result, the wheels 2f and 2r are braked. At this time, the motor generator 16 functions as a generator that supplies electric power to the battery 8 with the use of the torque. In the following, the function of the generator is mainly described among the functions of the motor generator 16. Therefore, the motor generator 16 may be referred to simply as “generator 16”.

The electrified vehicle 10 further includes first sensors 6f that detect rotation speeds of the front wheels 2f, second sensors 6r that detect rotation speeds of the rear wheels 2r, and a third sensor 18 that detects a rotation speed of the generator 16. Values detected by the sensors 6f, 6r, and 18 are transmitted to the control device 20.

The battery 8 includes a battery control device 9 capable of detecting a temperature and a state of charge (SOC) of the battery 8. The battery control device 9 calculates permissible charging power that is currently permissible for the battery 8, based on the temperature of the battery 8.

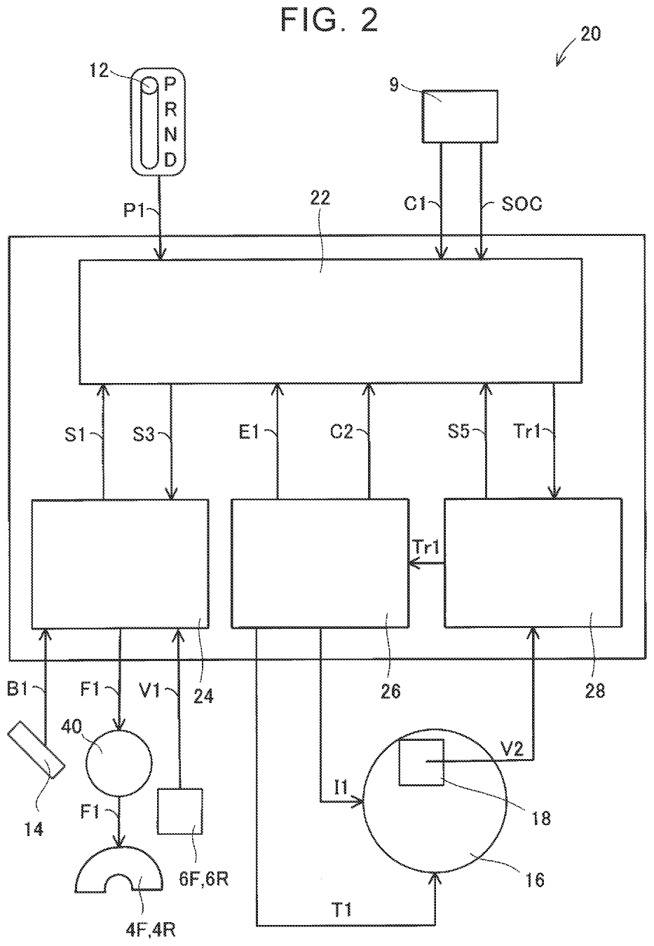

Details of the control device 20 will be described with reference to FIG. 2. The control device 20 is a computer that controls various functions of the electrified vehicle 10. Although illustration is omitted, the control device 20 includes an electronic circuit including a central processing unit (CPU), a random access memory (RAM), and a read only memory (ROM). The control device 20 includes a system control device 22, an anti-lock braking system (ABS) control device 24, a generator control device 26, and a vibration damping control device 28.

The ABS control device 24 is a control device for avoiding or restraining locking of the wheels 2f and 2r during braking of the wheels 2f and 2r, and performs so-called anti-lock braking system control (hereinafter referred to as “ABS control”). As shown in FIG. 2, when the ABS control device 24 receives a depression amount B1 of the brake pedal 14, the ABS control device 24 receives rotation speeds V1 of the wheels 2f and 2r from the first sensors 6f and the second sensors 6r. The ABS control device 24 calculates a slip ratio of each of the wheels 2f and 2r. When the calculated slip ratio is higher than a threshold, a hydraulic friction force (i.e., a friction force due to hydraulic pressure) F1 is applied to a corresponding one of the brakes 4f and 4r with the use of a pump 40 based on the slip ratio. As a result, the ABS control device 24 can avoid or restrain the locking of the wheels 2f and 2r. When the ABS control is performed in response to depression of the brake pedal 14 by the user and the ABS control device 24 receives a permission signal S3 described later, the ABS control device 24 transmits a request signal S1 to the system control device 22.

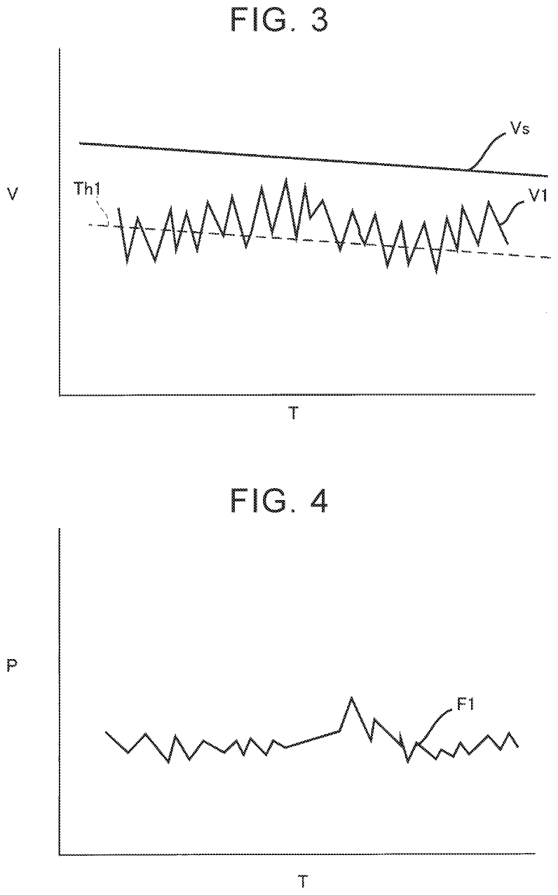

A relationship between the rotation speed V1 of each of the wheels 2f and 2r and the hydraulic friction force F1 applied to each of the wheels will be described with reference to FIGS. 3 and 4. FIG. 3 shows a relationship between an estimated speed Vs of the electrified vehicle 10 (see FIG. 1) and the rotation speed V1 of one wheel (hereinafter referred to as “target wheel”) among the wheels 2f and 2r in time sequence. The estimated speed Vs is calculated based on an average rotation speed of the wheels 2f and 2r. FIG. 4 shows a change in the friction force F1 applied to the target wheel in time sequence. When the brake pedal 14 is depressed, the estimated speed Vs gradually decreases depending on the depression amount B1. When the estimated speed Vs and the rotation speed V1 of the target wheel are lower than a threshold Th1, the ABS control device 24 determines that the target wheel is locked, and reduces the friction force F1 applied to the target wheel. When the estimated speed Vs and the rotation speed V1 of the target wheel are higher than the threshold Th1, the ABS control device 24 determines that the target wheel is not locked, and increases the friction force F1 applied to the target wheel. In this way, the ABS control device 24 monitors the rotation speed V1 of each of the wheels 2f and 2r, and controls the friction force F1 of each of the brakes 4f and 4r depending on the rotation speed V1 of a corresponding one of the wheels 2f and 2r, thereby avoiding or restraining the locking of each of the wheels 2f and 2r.

The rotation speed V1 includes a vibration component of a drive system including the wheels 2f and 2r and the generator 16. As shown in FIG. 3, the rotation speed V1 therefore changes while being repeatedly shifted up and down. Thus, the rotation speed V1 repeatedly exceeds the threshold Th1 in a relatively short period. As a result, the ABS control device 24 unnecessarily increases and decreases the friction force F1 as shown in FIG. 4. When the rotation speed V1 of the target wheel includes the vibration component, the ABS control device 24 cannot appropriately perform the ABS control.

As shown in FIG. 2, the vibration damping control device 28 receives a detected value of a rotation speed V2 of the generator 16 from the third sensor 18. The vibration damping control device 28 performs a bandpass process for extracting a component in a predetermined frequency band from the received detected value of the rotation speed V2. The predetermined frequency band includes a resonance frequency of the drive system, and is, for example, 5 to 15 Hz in the electrified vehicle 10 of the present embodiment. The predetermined frequency band is set depending on, for example, the size and mass of the electrified vehicle 10. The predetermined frequency band is prestored at the time of manufacturing the vibration damping control device 28.

After the component in the predetermined frequency band is extracted from the detected value of the rotation speed V2, the vibration damping control device 28 calculates a required torque threshold Tr1 by reversing the phase of the component. The vibration component included in the rotation speed V1 of the target wheel described with reference to FIG. 3 is also included in the rotation speed V2 of the generator 16. Through the bandpass process described above, the rotation speed V2 of the generator 16 is included in the same frequency band as that of the vibration component included in the rotation speed V1 of the target wheel. Therefore, the required torque threshold Tr1 that is included in the same frequency band as that of the vibration component and has the opposite phase is a value of a torque required to cancel or reduce the vibration component included in the rotation speed V1 of the target wheel. The vibration damping control device 28 transmits the calculated required torque threshold Tr1 to the system control device 22. The vibration damping control device 28 also transmits the calculated required torque threshold Tr1 to the generator control device 26.

The generator control device 26 controls the regenerative braking performed by the generator 16. When the vibration damping control is performed, the generator control device 26 transmits, to the generator 16, a current I1 for outputting a torque corresponding to the required torque threshold Tr1 received from the vibration damping control device 28. The generator control device 26 acquires a temperature T1 of the generator 16 from the generator 16. When the acquired temperature T1 is higher than a predetermined threshold temperature, the generator control device 26 determines that an abnormality has occurred in the generator 16, and transmits an abnormality signal E1 to the system control device 22. The generator control device 26 calculates permissible regenerative power C2 that is permissible for the generator 16 based on a state (for example, temperature) of the generator 16 at a present time, and transmits the permissible regenerative power C2 to the system control device 22. The permissible regenerative power C2 is an example of a limit value for the regenerative braking performed by the generator 16, and a permissible regenerative current may be adopted as another embodiment.

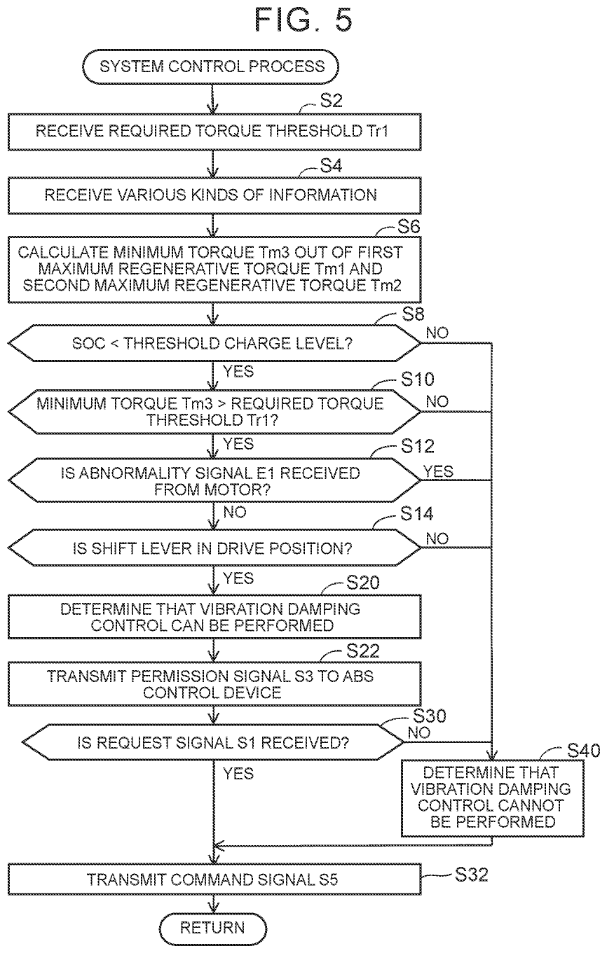

The system control device 22 can communicate with the control devices 24, 26, and 28. The system control device 22 receives, from the battery control device 9, a current SOC of the battery 8 and permissible charging power C1 calculated based on the temperature of the battery 8. The system control device 22 receives a current shift position P1 from the shift lever 12. As shown in FIG. 2, the shift position P1 is “P” indicating a parking position, “R” indicating a reverse position, “N” indicating a neutral position, or “D” indicating a drive position. The system control device 22 performs a system control process shown in FIG. 5 by receiving various kinds of information from the devices of the electrified vehicle 10. The permissible charging power C1 is an example of a limit value for the charging of the battery 8, and a permissible charging current may be adopted as another embodiment.

The system control process that is performed by the system control device 22 will be described with reference to FIG. 5. The system control device 22 repeats the system control process in every predetermined control cycle while the electrified vehicle 10 is traveling.

In Step S2, the system control device 22 receives the required torque threshold Tr1 from the vibration damping control device 28. In Step S4, the system control device 22 receives various kinds of information from various devices of the electrified vehicle 10. The various kinds of information include the SOC, the permissible charging power C1, the permissible regenerative power C2, the abnormality signal E1, and the shift position P1.

In Step S6, the system control device 22 calculates a first maximum regenerative torque Tm1 based on the permissible charging power C1, and calculates a second maximum regenerative torque Tm2 based on the permissible regenerative power C2. In Step S6, the system control device 22 also calculates a minimum torque Tm3 that is the minimum value out of the calculated maximum regenerative torques Tm1 and Tm2.

In Step S8, the system control device 22 determines whether the SOC received in S4 is lower than a threshold charge level. When the SOC is equal to or higher than the threshold charge level (NO in Step S8), the system control device 22 determines that the vibration damping control cannot be performed at the current SOC of the battery 8. The system control device 22 proceeds to Step S40 to determine that the vibration damping control should not be performed, and terminates the system control process.

When the SOC is lower than the threshold charge level (YES in Step S8), the system control device 22 compares, in Step S10, the minimum torque Tm3 with the required torque threshold Tr1 received in the process of S2. When the required torque threshold Tr1 is equal to or larger than the minimum torque Tm3 (NO in Step S10), the system control device 22 determines that the vibration damping control cannot be properly performed because the required torque threshold Tr1 that is a value of a torque required for the vibration damping control is equal to or larger than any one of the maximum regenerative torques Tm1 and Tm2. In this case, the system control device 22 proceeds to Step S40 to determine that the vibration damping control should not be performed, and terminates the system control process.

As described above, the system control device 22 determines that the vibration damping control should not be performed when the required torque threshold Tr1 that is a value of a torque required for the vibration damping control is equal to or larger than any one of the maximum regenerative torques Tm1 and Tm2. Therefore, the system control device 22 can determine more accurately whether the vibration damping control is performable (i.e., whether the vibration damping control can be performed).

The system control device 22 calculates the maximum regenerative torques Tm1 and Tm2 based on the permissible charging power C1 and the permissible regenerative power C2, respectively, and compares the maximum regenerative torques Tm1 and Tm2 with the required torque threshold Tr1. The comparison with the required torque threshold Tr1 can be appropriately made by converting the permissible regenerative power C2 and the permissible charging power C1 that are different indices into a common index that is a torque. Therefore, the system control device 22 can appropriately determine whether the vibration damping control can be performed.

When the required torque threshold Tr1 is smaller than the minimum torque Tm3, that is, when the minimum torque Tm3 is larger than the required torque threshold Tr1 (YES in Step S10), the system control device 22 determines in Step S12 whether the abnormality signal E1 is received from the generator control device 26. When the abnormality signal is received from the generator control device 26 (YES in Step S12), the system control device 22 determines that an abnormality has occurred in the generator 16, and proceeds to Step S40 to determine that the vibration damping control should not be performed. As a result, the system control device 22 can reduce the possibility that a load due to the vibration damping control is additionally applied to the generator 16 having the abnormality.

When the abnormality signal E1 is not received from the generator control device 26 (NO in Step S12), the system control device 22 determines in Step S14 whether the shift lever 12 is in the drive position (that is, the position other than the parking position, the reverse position, and the neutral position). Specifically, the system control device 22 checks in Step S14 whether the shift position P1 received in S4 is “D”. When the shift lever 12 is not in the drive position (NO in Step S14), the system control device 22 proceeds to Step S40 to determine that the vibration damping control should not be performed, and terminates the system control process. As a result, the system control device 22 can reduce the possibility that the vibration damping control is unnecessarily performed when the shift lever 12 is in, for example, the parking position.

When the shift lever 12 is in the drive position (YES in Step S14), the system control device 22 determines in Step S20 that the vibration damping control can be performed. In that case, the system control device 22 transmits the permission signal S3 to the ABS control device 24 in Step S22.

In Step S30, the system control device 22 determines whether the request signal S1 is received from the ABS control device 24. As described above, when the ABS control is performed in response to depression of the brake pedal 14 by the user and the ABS control device 24 receives the permission signal S3, the ABS control device 24 transmits the request signal S1 to the system control device 22.

When the request signal S1 is not received from the ABS control device 24 (NO in Step S30), the system control device 22 determines that the ABS control is not being performed. In this case, the system control device 22 proceeds to Step S40 to determine that the vibration damping control should not be performed, and terminates the system control process.

When the request signal S1 is received from the ABS control device 24 (YES in Step S30), the system control device 22 transmits a command signal S5 to the vibration damping control device 28 to perform the vibration damping control in Step S32, and terminates the system control process.

When the command signal S5 is received, the vibration damping control device 28 transmits the required torque threshold Tr1 to the generator control device 26. The generator control device 26 supplies, to the generator 16, the current I1 for causing the generator 16 to output a torque corresponding to the received required torque threshold Tr1. Therefore, the generator 16 can apply the torque corresponding to the required torque threshold Tr1 to each of the wheels 2f and 2r. As a result, the vibration component included in the rotation speed V1 described with reference to FIG. 3 is canceled or reduced.

As described above, the system control device 22 of the embodiment transmits the permission signal S3 to the ABS control device 24 in Step S22 when the system control device 22 determines that the vibration damping control can be performed. Therefore, the ABS control device 24 can grasp whether it is possible to perform the vibration damping control using the regenerative braking performed by the generator 16 at a present time. Thus, the ABS control device 24 can change, for example, a control parameter of the ABS control such that the control parameter under the situation in which the vibration damping control can be expected is different from the control parameter under the situation in which the vibration damping control cannot be expected.

The system control device 22 transmits the command signal S5 to the vibration damping control device 28 when the system control device 22 compares the SOC of the battery 8 with the threshold charge level and determines that the battery 8 can be charged when the vibration damping control is performed, and receives the request signal S1 from the ABS control device 24. As a result, the control performed by the ABS control device 24 and the vibration damping control device 28 is simplified. Thus, the control is less likely to be disturbed. In the electrified vehicle 10 disclosed herein, it is possible to reduce the possibility that insufficient vibration damping control is performed during the ABS control.

Although the specific examples of the present disclosure are described in detail above, these examples are only illustrative and are not intended to limit the scope of claims. The present disclosure described in the claims includes various modifications and changes of the specific examples illustrated above. Modifications of the embodiment described above are described below.

### First Modification

The system control device 22 may not receive the permissible charging power C1 from the battery control device 9 in Step S4. In that case, the system control device 22 may calculate the second maximum regenerative torque Tm2 as the minimum torque Tm3 in Step S6.

### Second Modification

The system control device 22 may not receive the permissible regenerative power C2 from the generator control device 26 in Step S4. In that case, the system control device 22 may calculate the first maximum regenerative torque Tm1 as the minimum torque Tm3 in Step S6.

### Third Modification

The system control device 22 may not receive the abnormality signal E1 from the generator control device 26 in Step S4. In that case, the process of Step S12 can be omitted.

### Fourth Modification

The system control device 22 may not receive the shift position P1 from the shift lever 12 in Step S4. In that case, the process of Step S14 can be omitted.

### Fifth Modification

The generator control device 26 may determine that an abnormality has occurred in the generator 16 and transmit the abnormality signal E1 to the system control device 22 when the rotation speed V2 of the generator 16 is higher than a threshold instead of using the temperature T1 of the generator 16.

### Sixth Modification

The system control device 22 may perform the system control process in response to reception of the request signal S1 from the ABS control device 24.

The technical elements described herein or illustrated in the drawings exhibit technical utility solely or in various combinations, and are not limited to the combination described in the claims as filed. The technologies described herein or illustrated in the drawings may simultaneously achieve a plurality of objects, and exhibit technical utility by achieving one of the objects.

What is claimed is:

1. An electrified vehicle comprising:
a motor generator configured to drive a wheel;
a battery connected to the motor generator;
a generator control device configured to control regenerative braking performed by the motor generator;
a braking device configured to mechanically brake the wheel;
an anti-lock braking system control device configured to perform anti-lock braking system control for avoiding or restraining locking of the wheel by monitoring a rotation speed of the wheel and controlling the braking device depending on the rotation speed;
a vibration damping control device configured to perform vibration damping control for canceling or reducing, with use of the regenerative braking, a predetermined vibration component generated in a rotation speed of the motor generator, by monitoring the predetermined vibration component and controlling the generator control device depending on the predetermined vibration component; and
a system control device configured to determine whether the vibration damping control is performable based on at least a charge status of the battery, wherein
the anti-lock braking system control device is configured to transmit a request signal to the system control device while the anti-lock braking system control device is performing the anti-lock braking system control,
the system control device is configured to transmit a command signal to the vibration damping control device when the system control device determines that the vibration damping control is performable and receives the request signal from the anti-lock braking system control device, and
the vibration damping control device is configured to perform the vibration damping control when the vibration damping control device receives the command signal from the system control device.

2. The electrified vehicle according to claim 1, wherein the system control device is configured to determine whether the vibration damping control is performable based further on a limit value for charging of the battery.

3. The electrified vehicle according to claim 1, wherein the system control device is configured to determine whether the vibration damping control is performable based further on a limit value for the regenerative braking performed by the motor generator.

4. The electrified vehicle according to claim 1, wherein the system control device is configured to
calculate, based on a limit value for charging of the battery, a first maximum regenerative torque outputtable in the regenerative braking by the motor generator,
calculate, based on a limit value for the regenerative braking performed by the motor generator, a second maximum regenerative torque outputtable in the regenerative braking by the motor generator, and
determine that the vibration damping control is performable when a minimum value out of the first maximum regenerative torque and the second maximum regenerative torque is larger than a required torque threshold that is a value of a torque required for performing the vibration damping control.

5. The electrified vehicle according to claim 1, wherein:
the system control device is configured to transmit a permission signal to the anti-lock braking system control device when the system control device determines that the vibration damping control is performable; and
the anti-lock braking system control device is configured to transmit the request signal to the system control device when the anti-lock braking system control device receives the permission signal and is performing the anti-lock braking system control.

6. The electrified vehicle according to claim 1, wherein the system control device is configured to determine whether the vibration damping control is performable based further on whether an abnormality has occurred in the motor generator.

7. The electrified vehicle according to claim 1, further comprising a shift lever, wherein the system control device is configured to determine whether the vibration damping control is performable based further on whether the shift lever is in a drive position.
